(19) United States
(12) Patent Application Publication
(10) Pub. No.: US 2016/0092607 A1
(43) Pub. Date: Mar. 31, 2016

(54) METHOD FOR ALLOY DESIGN COMBINING RESPONSE SURFACE METHOD AND ARTIFICIAL NEURAL NETWORK

(71) Applicant: Korea Institute of Machinery & Materials, Daejeon (KR)

(72) Inventors: Young Soo YOO, Gyeongsangnam-do (KR); Hi Won JEONG, Gyeongsangnam-do (KR); Seong Moon SEO, Gyeongsangnam-do (KR); Dae Won YUN, Gyeongsangnam-do (KR)

(21) Appl. No.: 14/558,492

(22) Filed: Dec. 2, 2014

(30) Foreign Application Priority Data
Sep. 30, 2014 (KR) 10-2014-0131976

(51) Int. Cl. G06F 17/50; G06N 3/04

(52) U.S. Cl. CPC G06F 17/50; G06N 3/04

(57) ABSTRACT

There is provided a method for alloy design combining a response surface method and an artificial neural network that can significantly reduce the number of times, the time, and the cost for experiments by designing the minimum experiments using a response surface method, obtaining results through actual experiments, and modeling the obtained results using an artificial neural network.

The method for alloy design combining a response surface method and an artificial neural network designs an experiment using a response surface method, obtains a result through an actual experiment, and models alloy composition by applying the obtained result to an artificial neural network.

### CROSS-REFERENCE TO RELATED APPLICATIONS

This application claims priority to Korean Patent Application No. 10-2014-0131976, filed on Sep. 30, 2014 and entitled “METHOD FOR ALLOY DESIGN COMBINING RESPONSE SURFACE METHOD AND ARTIFICIAL NEURAL NETWORK”. The disclosures of the foregoing applications are incorporated herein by reference in their entirety.

### BACKGROUND OF THE INVENTION

1. Field of the Invention

The present invention relates to a method for alloy design combining a response surface method and an artificial neural network, and more particularly, to a method of alloy design combining a response surface method and an artificial neural network which designs a plurality of experiments, using a response surface method, obtains results from actual experiments, and models the results by applying them to an artificial neural network.

2. Description of the Related Art

The term ‘alloy design’ may be considered as optimization of process parameters such as heat treatment in its broad sense, but generally means adjustment of chemical composition parameters and determination of alloy composition having the optimum properties.

In general, design of alloy composition is the most important factor for manufacturing an alloy of which specific properties such as creep rupture life, tensile strength, and oxidation characteristic are excellent.

The alloy design is achieved by a trial-and-error method or data modeling. The trial-and-error method is to design alloy composition by manufacturing and analyzing an alloy having various components, but it takes too much time and cost since it is required to repeat many experiments and analyses in order to obtain an alloy composition having desired properties.

Designing through data modeling, which is a method of statistically designing an alloy composition using given data or database with various analyzing techniques, uses multiple linear regression or an artificial neural network. The data modeling has been used for alloy design over the past several decades, and particularly, the artificial neural network has been widely used since 1990s.

The most peculiar characteristic of the artificial neural network modeled on the human brain structure is learning from data. An artificial neural network can be used for pattern recognition when it learns from graphic data, it can be used for voice recognition when it learns from sound data, and it can be used for data modeling such as regression or classification when it learns from a numerical data.

As described above, the artificial neural network is a mathematical model programmed on the basis of the brain structure of human. A neuron biologically means a basic nerve cell and is a basic factor of a nervous tissue. Such a neuron is composed of a body of a cell called a cell body, a dendrite, and an axon, as shown in FIG. 1A, neurons or a neuron and another cell are connected by a synapse.

As shown in FIG. 1B, a modeling technique of modeling a network composed of neurons and synapses by imitating the nerve cells of a human brain and of finding a pattern in data collected in the past by repeating learning from the data is the artificial neural network.

There are various models in the artificial neural network, but a multilayer preceptron (MLP) is the most popular model for data analysis. The multilayer perceptron is composed of an input layer, a hidden layer composed of hidden units, and an output layer (described in detail in the following architecture).

There is a need for actually-measured data (previous data) for learning in order to use the artificial neural network method and all of combinations of levels that design variables may have is made by full factorial design for data measurement.

Typical ones of the full factorial design are 2 level factorial design that makes all of design variables as 2 level and 3 level factorial design that makes all of design variable as 3 level, and the number of times of experiments of them are 2^{NDV} (NDV: The Number of Design Variables) and 3^{NVD} respectively.

The applicant(s) has applied for patents “single crystal Ni based superalloy having excellent high temperature creep characteristic” (Korean Patent Publication Application No. 10-2004-0008381) and “Ni-based single crystal superalloy” (Korean Patent No. 10-0725624) for designing an alloy using an artificial neural network.

However, there is a need for previous data for learning in order to design alloy composition using an artificial neural network, and there is a need for a great amount of previous data in order to increase reliability of obtained results.

That is, in order to design an alloy of which specific properties are excellent using an artificial neural network, there is a need for data of which properties changed in accordance with the contents of elements of the alloy was measured, but it is impossible to actually measure all the properties for the content of each element in an alloy containing ten or more elements such as a superalloy.

The following Table 1 shows the number of times of experiments that have to be performed when three to seven factors (variables) are combined to 3 level using full factorial design.

TABLE 1

| | Full factorial design |
|---|---|
| 3 Level 3 Factor | 27(=3³) |
| (3 Level 3 Factor) | |
| 3 Level 4 Factor | 81(=3⁴) |
| (3 Level 3 Factor) | |
| 3 Level 5 Factor | 243(=3⁵) |
| (3 Level 3 Factor) | |
| 3 Level 6 Factor | 729(=3⁶) |
| (3 Level 3 Factor) | |
| 3 Level 7 Factor | 2,187(=3⁷) |
| (3 Level 3 Factor) | |

For example, considering seven elements of cobalt (Co), chromium (Cr), molybdenum (Mo), tungsten (W), aluminum (Al), titanium (Ti), and tantalum (Ta), which influence the oxidation characteristic of a Ni-based superalloy, the number of times of experiments using 3 level full factorial design is 2,187 times.

That is, it is possible to model alloy composition having the optimum oxidation characteristic by measuring an oxidation characteristic of 2,187 pieces of alloy samples and then applying an artificial neural network, using the measured value.

However, it is actually almost impossible to measure the oxidation characteristic of 2,187 pieces of alloy samples, which means that it is impossible to use an artificial neural network unless there is a great amount of actually-measured previous data.

### DOCUMENTS OF RELATED ART

### Patent Document

(Patent Document 1) Korean Patent Application Publication No. 10-2004-0008381 (Jan. 1, 2004)

(Patent Document 2) Korean Patent No. 10-0725624 (May 5, 2007)

### SUMMARY OF THE INVENTION

The present invention has been made in an effort to provide to a method for alloy design combining a response surface method and an artificial neural network that can significantly reduce the number of times, the time, and the cost of experiments by designing the minimum experiments using a response surface method, obtaining results through actual experiments, and modeling the obtained results using an artificial neural network.

According to an aspect of the present invention, there is provided a method for alloy design combining a response surface method and an artificial neural network that designs an experiment using a response surface method, obtains a result through an actual experiment, and models alloy composition by applying the obtained result to an artificial neural network.

The method may include: a first step of setting up conditions relating to the element determining properties of an alloy; a second step of designing an experiment by applying the conditions set up in the first step to the response surface method; a third step of obtaining a result by performing an actual experiment on the basis of the designed experiment; and a fourth step of modeling alloy composite by applying the designed experiment and the result to the artificial neural network.

The first step may determine conditions including the number, kind, content, and level of elements.

The response surface method may be box-behnken design.

The result obtained through the four steps may be that a multiple correlation coefficient between an experimented value and an estimated value is 0.9 or more.

The present invention has various effects as follows.

First, it is possible to significantly decrease the number of times, the time, and the cost of experiments when designing an alloy that contains various elements.

Second, it is possible to obtain data with very high reliability only through the minimum process when designing an unknown alloy without previous data.

Third, it is very effective to design an alloy of which specific properties are excellent.

Fourth, it is useful to estimate properties of an alloy having unknown composition.

Fifth, its reliability is very high since a very high multiple correlation coefficient is achieved as compared with when only a response surface method is used.

Sixth, it is possible to design various alloys having similar properties depending upon the level of knowledge of the user.

Seventh, it is possible to achieve the same effects, which can be obtained when performing thousands of experiments (full factorial design), by performing only tens of experiments in accordance with the number of input variables.

### BRIEF DESCRIPTION OF THE DRAWINGS

FIGS. 1A and 1B are diagrams showing the biological structure of a neuron and showing a standard model of an artificial neural network method, respectively.

FIG. 2 is a flowchart illustrating a method for alloy design combining a response surface method and an artificial neural network according to the present invention.

FIG. 3 is a schematic diagram showing 3-4-3-1 architecture of an artificial neural network.

FIG. 4 is a graph showing an oxidation characteristic of sixty two alloy samples according to the present invention.

FIG. 5 is a graph analyzing a multiple correlation coefficient between an experimented value and an estimated value after modeling an experiment result using an estimation model of a response surface method.

FIG. 6 is a graph analyzing a multiple correlation coefficient between an experimented value and an estimated value after modeling an experiment result using an estimation model combining a response surface method and an artificial neural network according to the present invention.

FIG. 7 is a graph showing an error bar of FIG. 6 according to the present invention.

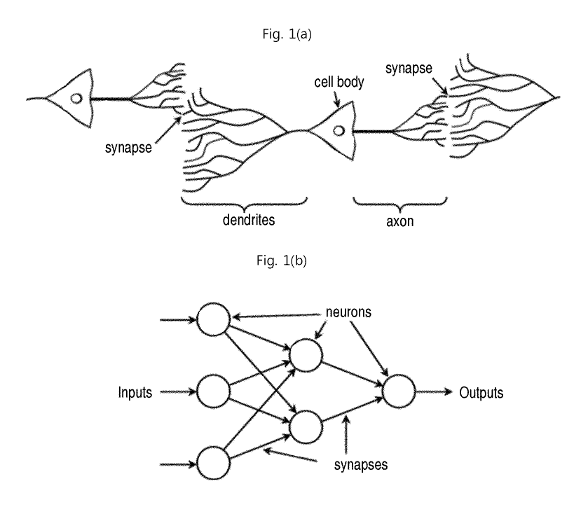

### DETAILED DESCRIPTION OF THE PREFERRED EMBODIMENTS

An embodiment of the present invention is described hereafter with reference to the accompanying drawings and the reference numerals used in the background art and the configuration described above are applied in the same way, if not specifically stated.

The following description for to a method for alloy design combining a response surface method and an artificial neural network of the present invention is a preferred embodiment of the present invention and the present invention is not limited thereto and may implemented in various ways.

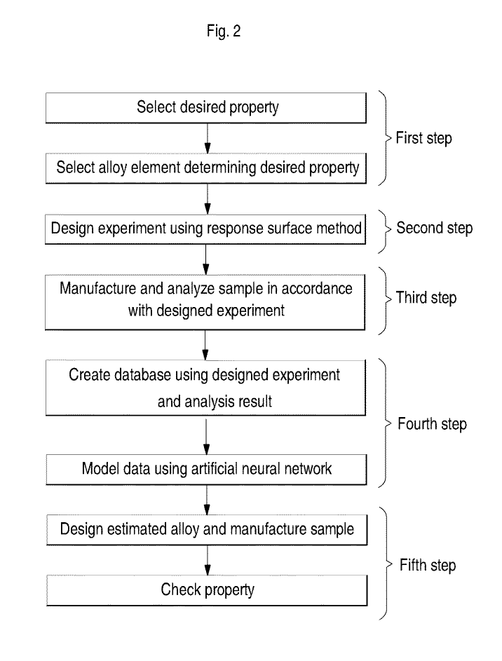

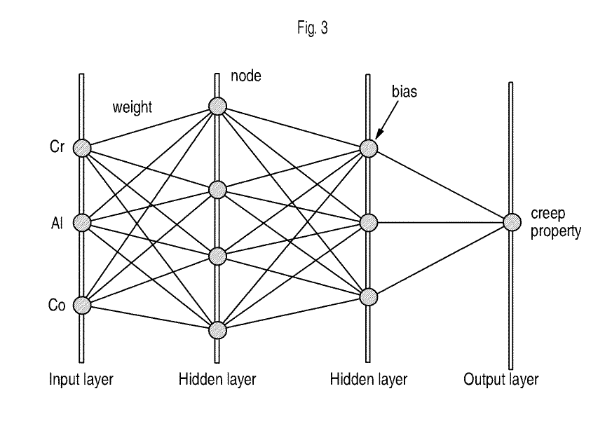

As shown in FIG. 2, a method for alloy design combining a response surface method and an artificial neural network according to an embodiment of the present invention designs an experiment using a response surface method, obtains a result through an actual experiment, and models alloy composition by applying the obtained result to an artificial neural network.

As described above, the artificial neural network is a design technique that estimates properties of an alloy by modeling alloy composition on the basis of a great amount of previous data, and to this end, it should take precedence to obtain a database arranged in accordance with alloy composition and properties.

The data is obtained by actual experiments, and as shown in the above Table 1, the larger the number of composition (factors), the more the number of alloys to manufacture and to analyze increases in an arithmetical progression.

In the following description, modeling of a superalloy having an excellent oxidation characteristic (oxidation resistance) is exemplified for the convenience of description and help understand the present invention, but the oxidation characteristic and the superalloy are just examples and the kind and characteristic of alloys may be variously changed.

A superalloy having nickel (Ni) as the main element is composed of about ten or more elements, and in those elements, cobalt (Co), chromium (Cr), molybdenum (Mo), tungsten (W), aluminum (Al), titanium (Ti), and tantalum (Ta) are the main elements determine the oxidation characteristic.

When experiment conditions for seven elements are designed using 3 level full factorial design, which is one of the full factorial designs, to ensure data for an artificial neural network, an experiment number of 2,187 is obtained as in Table 1.

2,187 is the number of alloy samples to manufacture, which means the number of times of experiments and the content combinations of seven elements are different in the samples.

However, it is actually difficult to manufacture 2,387 pieces of samples and analyze their characteristics, so the applicant(s) has greatly reduced the number of experiments using a response surface method (RSM), which is one of design of experiments and obtained results from actual experiments.

The response surface method, also called response surface design (RSD), means a method of estimating combination effects of several independent variables without performing a factor design experiment on each level of all of independent variables.

The response surface method, which is used to examine the relationships between one or more response variables (dependent variables) with experiment variables, is generally used after a small number of control factors are recognized and the designer finds factors optimizing responses.

The response surface method estimates how the response amount changes depending upon a change in value of independent variables by estimating functional relationships between independent variables and response variables from data and finds which values of the independent variables the response amount is optimized at.

That is, it is possible to consider what is the experiment plan showing the best response from the smallest number of experiments and find out statistical properties of a suitable response surface estimated by analyzing data.

Further, the response surface method needs to be able to independently estimate coefficients of a secondary linear model and the experiment sections at the same distance from the origin should be the same in distribution of an estimated response surface equation. Those two conditions are very important determination factors of the response surface method and are called orthogonality and rotatability.

In order to design alloy composition using the response surface method, the number of levels of factors should be determined first. When design is progressed with too much levels, however, the number of times of experiments increases in an arithmetical progression, so it is preferable to design alloy composition with two levels or three levels where the highest reliability can be achieved with the smallest number of times of experiments.

However, it is difficult to make a response curved surface with two levels, so three or more levels are preferable, and in an embodiment, design was made with three levels to achieve the minimum number of times of experiments and the highest reliability.

The method for alloy design combining a response surface method and an artificial neural network according to the present invention may be largely divided into four steps in detail.

The first step is to set up conditions relating to the element determining properties of an alloy, in which the properties of the alloy mean desired properties (oxidation characteristic in the embodiment).

The conditions relating to the elements to be designed include the number, kind, content and level of the elements, and the standards of each condition depend on the designer.

The second step is to perform experiment design by applying the conditions relating to the element determined in the first step to a response surface method.

The third step is to obtain results of the properties of alloy samples by manufacturing and analyzing the alloy samples through actual experiments performed on the basis of the experiment designed in the second step.

The fourth step is to create a database using the experiment designed in the second step and the results obtained in the third step and then to model alloy composition by applying an artificial neural network, and it is preferable to add a fifth step to design and manufacture estimated alloys on the basis of the modeled alloy composition and to check the properties.

Architecture is used when the artificial neural network is applied in the fourth step. The architecture is changed in various ways depending upon the object of the designer, and an example of 3-4-3-1 architecture is shown in FIG. 3 to help understanding. As for the numbers, the first 3 means the number of nodes of an input layer, the last 1 means the number of nodes of an output layer, and 4 and 3 in the middle mean the numbers of nodes of hidden layers.

There are two different methods for the response surface method, which are central composite design (CCD) and Box-Behnken design (BBD). When the response surface method is used in the second step, it is preferable to apply the Box-Behnken design since reliability of the designed experiment may decreases if the central composite design is used.

The central composite design is made generally with five levels, and when it is performed with three levels, rotatability is not satisfied due to a cubic experiment section. Accordingly, it is preferable to apply a spherical experiment section and the box-behnken design having rotatability or approximate rotatability for three levels.

Further, in central composite design with three levels using seven factors, the number of times of experiments (the number of alloy samples) is 152, over doubling 62 of the box-behnken design, so it is preferable to use the box-behnken design for the minimum number of times of experiments.

As described above, the box-behnken design can greatly reduce the number of times of experiments to perform in order to achieve data in comparison to the full factorial design, and this advantage can be seen in more detail in the following Table 2.

Table 2 shows the number of times of experiments to perform when three to seven factors are combined with three levels using full factorial design or box-behnken design.

TABLE 2

| | Full factorial design | Box-behnken design |
|---|---|---|
| 3 Level 3 Factors | 27(=3³) | 15 |
| 3 Level 4 Factors | 81(=3⁴) | 27 |
| 3 Level 5 Factors | 243(=3⁵) | 46 |
| 3 Level 6 Factors | 729(=3⁶) | 54 |
| 3 Level 7 Factors | 2,187(=3⁷) | 62 |

As shown in Table 2, it can be seen that in the full factorial design, the larger the number of factors, the more the number of times of experiments increases in an arithmetical progression, but in the box-behnken design, the number of times of experiments considerably decreases in comparison to the full factorial design.

The reliability of the modeled results depends on the multiple correlation coefficient (MCC) obtained when an actual alloy sample is manufactured with the designed alloy composition and is analyzed. When the results are less than 0.9, a large error is generated as the reliability is low.

This means that it is insufficient to exactly estimate the properties of an alloy having unknown composition, so the resultant obtained through the four steps should have a multiple correlation coefficient over 0.9 between the experimented value and the estimated value.

An actual modeling process of a superalloy having an excellent oxidation characteristic using the present invention is described hereafter.

The applicant(s) has selected seven elements cobalt (Co), chromium (Cr), molybdenum (Mo), tungsten (W), aluminum (Al), titanium (Ti), and tantalum (Ta) to determine the oxidation characteristic among the elements of a superalloy and has selected the contents of the elements with three levels (first step).

The following Table 3 shows the first step conditions of a superalloy having an excellent oxidation characteristic.

TABLE 3

| Alloying | Level | | |
|---|---|---|---|
| Elements | −1 | 0 | +1 |
| Co | 0.0 | 0.75 | 15.0 |
| Cr | 8.0 | 11.5 | 15.0 |
| Mo | 0.0 | 2.5 | 5.0 |
| W | 0.0 | 5.0 | 10.0 |
| Al | 3.0 | 5.5 | 8.0 |
| Ti | 0.0 | 0.25 | 5.0 |
| Ta | 0.0 | 5.0 | 10.0 |

(in wt %)

Sixty two experiments were designed by applying box-behnken design of a response surface method to the conditions set up as described above, and some of them are shown in the following Table 4 (second step).

TABLE 4

| No. | Co | Cr | Mo | W | Al | Ti | Ta |
|---|---|---|---|---|---|---|---|
| 1 | 7.5 | 11.5 | 2.5 | 0 | 3 | 0 | 5 |
| 2 | 7.5 | 11.5 | 2.5 | 10 | 8 | 0 | 5 |
| 3 | 7.5 | 11.5 | 2.5 | 10 | 3 | 5 | 5 |
| 4 | 7.5 | 11.5 | 2.5 | 0 | 8 | 5 | 5 |
| 5 | 0 | 11.5 | 2.5 | 5 | 5.5 | 0 | 0 |
| 6 | 15 | 11.5 | 2.5 | 5 | 5.5 | 5 | 0 |
| 7 | 15 | 11.5 | 2.5 | 5 | 5.5 | 0 | 10 |
| 8 | 0 | 11.5 | 2.5 | 5 | 5.5 | 5 | 10 |
| 9 | 7.5 | 8 | 2.5 | 5 | 3 | 2.5 | 0 |
| 10 | 7.5 | 15 | 2.5 | 5 | 8 | 2.5 | 0 |
| 11 | 7.5 | 15 | 2.5 | 5 | 3 | 2.5 | 10 |
| 12 | 7.5 | 8 | 2.5 | 5 | 8 | 2.5 | 10 |
| 13 | 0 | 8 | 2.5 | 0 | 5.5 | 2.5 | 5 |
| 14 | 15 | 15 | 2.5 | 0 | 5.5 | 2.5 | 5 |
| 15 | 15 | 8 | 2.5 | 10 | 5.5 | 2.5 | 5 |
| 16 | 0 | 15 | 2.5 | 10 | 5.5 | 2.5 | 5 |
| . | . | . | . | . | . | . | . |
| . | . | . | . | . | . | . | . |
| . | . | . | . | . | . | . | . |
| 62 | 7.5 | 11.5 | 2.5 | 5 | 5.5 | 2.5 | 5 |

(in wt %)

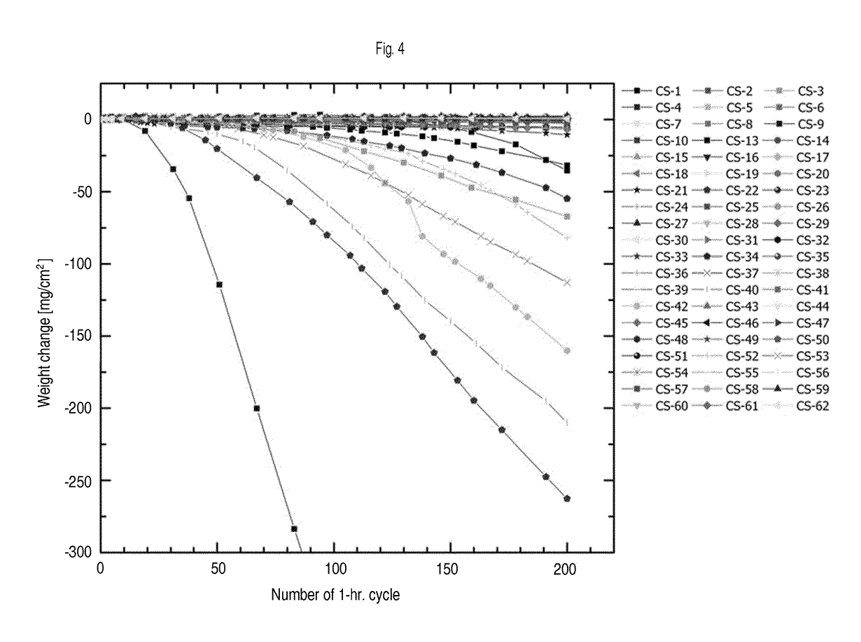

Sixty two alloy samples were manufactured on the basis of the experiments designed as described above, changes in weight were measured by performing an oxidation experiment on the alloy samples for one hour, and the results were shown as a graph in FIG. 4 (third step). The oxidation experiments were performed by total two hundreds of cycles, in which one cycle was ‘maintaining for one hour at 1,100° C.-maintaining for one hour at room temperature’.

As shown in FIG. 4, it can be seen that the amount of change in weight according to an increase in the number of cycles is different depending upon the composite of the alloys and that there are both of alloy samples of which the weight rapidly decreases and alloy samples of which the weight little changes.

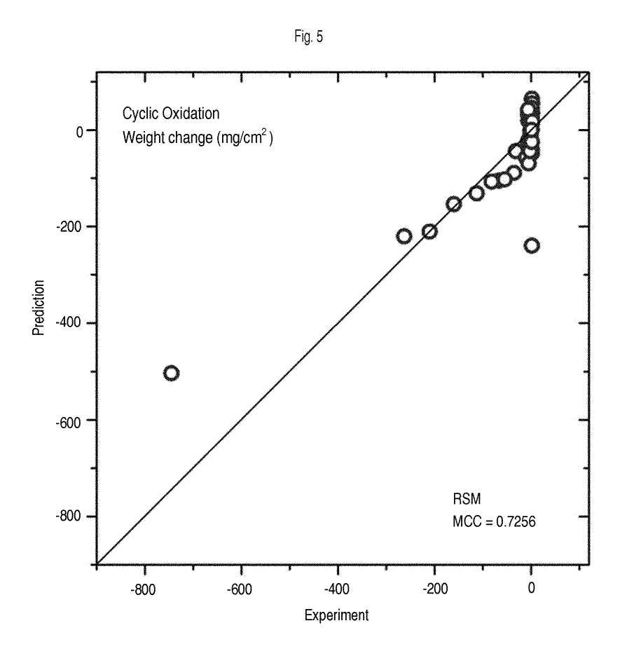

There is a technique of not only designing experiments, but modeling alloy composite similar to the artificial neural network in the response surface method. The result of modeling an alloy composite using only a response surface method is shown in FIG. 5 to compare the result of modeling alloy composition by combining an experiment designed by a response surface method with an artificial neural network (present invention) with the result of modeling alloy composition using only a response surface method.

As shown in FIG. 5, it can be seen that when alloy composite was modeled only by a response surface method, the multiple correlation coefficient (MCC) was 0.7256 and there was a large error between the estimated value and the actually-measured value.

The multiple correlation coefficient means the reliability in the modeling and comes close to 1, as the estimated value and the actually-measure value become similar.

As described above, the reliability can be considered as being high when the multiple correlation coefficient obtained by modeling is at least 0.9 or more, but the multiple correlation coefficient (MCC) is 0.7256 when alloy composite is modeled only by a response surface method, so it can be considered that the reliability of the result is very low.

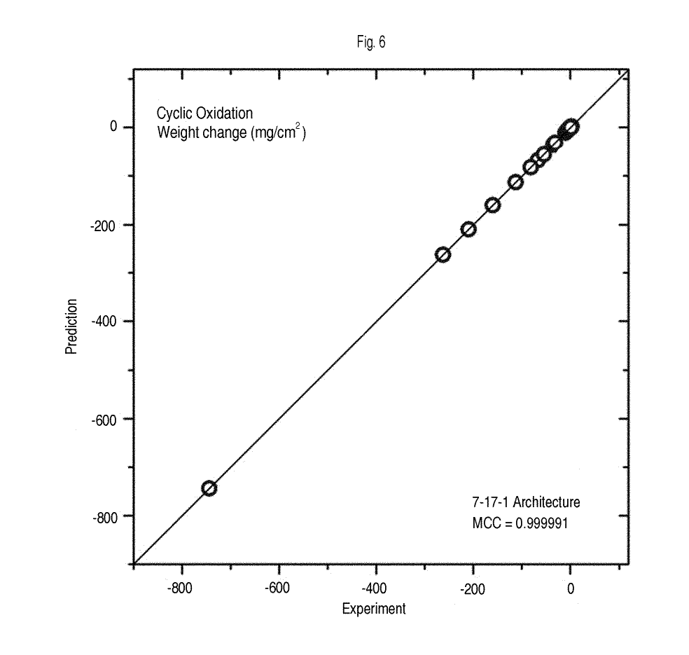

FIG. 6 shows a graph analyzing a multiple correlation coefficient after modeling alloy composite by applying an artificial neural network to the experiments designed in the second step and the data of the oxidation characteristic obtained in the third step, in which an artificial neural network of 7-17-1 architecture was used.

It can be seen from FIG. 6 that when the experiments designed by a response surface method are modeled by applying an artificial neural network, the multiple correlation coefficient is 0.999991—that is, a value almost close to 1 can be obtained and there is little error between the estimated value and the actually-measured value.

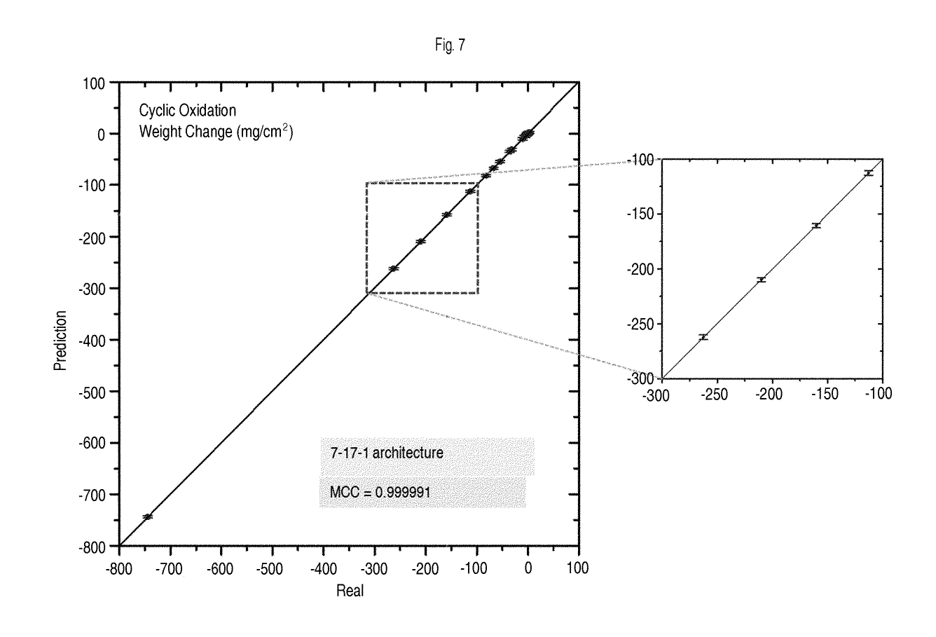

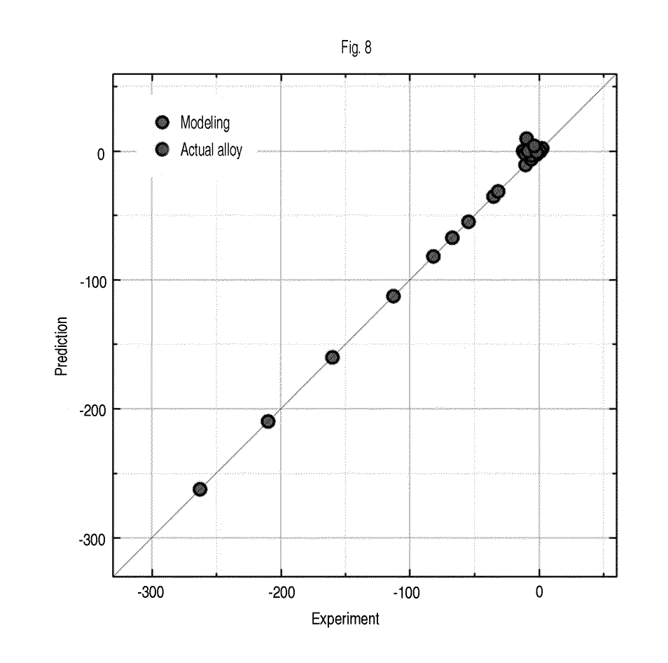

In particular as shown in FIG. 7, this type of modeling shows a very small error bar, and it can be further seen that the reliability of the estimated value is very high.

As the result of manufacturing actual alloys on the basis of eight alloy compositions that are not included in the sixty two alloy compositions modeled in accordance with the present invention and then analyzing their oxidation characteristics, it could be seen that it was almost similar to the modeling result shown in FIG. 8.

Although the present invention was described above in detail by means of embodiments, the present invention is not limited to the specific embodiments and should be construed on the basis of claims. Further, it should be understood that the present invention may be changed and modified in various ways by those skilled in the art without departing from the scope of the present invention.

What is claimed is:

1. A method for alloy design combining a response surface method and an artificial neural network, which designs an experiment using a response surface method, obtains a result through an actual experiment, and models alloy composition by applying the obtained result to an artificial neural network.

2. The method of claim 1, comprising:
a first step of setting up conditions relating to an element determining properties of an alloy;
a second step of designing an experiment by applying the conditions set up in the first step to the response surface method;
a third step of obtaining a result by performing an actual experiment on the basis of the designed experiment; and
a fourth step of modeling alloy composite by applying the designed experiment and the result to the artificial neural network.

3. The method of claim 2, wherein the first step determines conditions including the number, kind, content, and level of elements.

4. The method of claim 1, wherein the response surface method is box-behnken design.

5. The method of claim 2, wherein the response surface method is box-behnken design.

6. The method of claim 2, wherein the result obtained in the fourth step is that a multiple correlation coefficient between an experimented value and an estimated value is 0.9 or more.

7. A method for alloy design, comprising:
a first step of setting up conditions relating to the element determining properties of an alloy;
a second step of designing an experiment by applying the conditions set up in the first step;
a third step of obtaining a result by performing an actual experiment on the basis of the designed experiment; and
a fourth step of modeling alloy composite by applying the designed experiment and the result to an artificial neural network.
